(19) United States
(12) Patent Application Publication
(10) Pub. No.: US 2020/0244626 A1
(43) Pub. Date: Jul. 30, 2020

(54) ELECTRONIC DEVICE AND OPERATING METHOD OF THE SAME

(71) Applicant: SAMSUNG ELECTRONICS CO., LTD., Suwon-si (KR)

(72) Inventors: Sejeong KWON, Suwon-si (KR); Heejae YU, Suwon-si (KR)

(21) Appl. No.: 16/727,286

(22) Filed: Dec. 26, 2019

(30) Foreign Application Priority Data
Jan. 24, 2019 (KR) 10-2019-0009236

(51) Int. Cl. H04L 29/06; G06F 21/62

(52) U.S. Cl. CPC H04L 63/0421; H04L 63/0861; H04L 67/1097; G06F 21/6218; H04L 63/083

(57) ABSTRACT

Provided are a first device and a method of operating thereof. The first device includes: a communicator comprising communication circuitry; a memory configured to store one or more instructions; and a processor configured to execute the one or more instructions stored in the memory, wherein the processor is configured to control the first device to: extract sensitive information included in original content to be shared, to perform anonymization on the sensitive information to create anonymized content corresponding to the original content, to control the communicator to transmit the anonymized content to a second device, to perform, based on a request for the original content being received from the second device through the communicator, authentication in response to the request, and transmit the original content to the second device based on the authentication being completed.

### CROSS-REFERENCE TO RELATED APPLICATION

This application is based on and claims priority under 35 U.S.C. § 119 to Korean Patent Application No. 10-2019-0009236, filed on Jan. 24, 2019, in the Korean Intellectual Property Office, the disclosure of which is incorporated by reference herein in its entirety.

### BACKGROUND

### 1. Field

The disclosure relates to an electronic device and an operating method thereof, and for example, to an electronic device capable of sharing content including sensitive information with an external device, and an operating method of the electronic device.

### 2. Description of Related Art

Recently, with the expansion of information communication networks, illegal outflow, abuse, collection, etc. of personal information are increasing. Accordingly, awareness of the importance of protecting personal information has been raised.

Also, with the spread of smart phones and the commercialization of the Internet, content including sensitive information such as personal information is actively circulating. However, when such sensitive information is unintentionally shared or uploaded, significant social, financial loss may occur.

Accordingly, before sharing content including sensitive information with an external device or uploading the content, a method of enabling a user to recognize the content including the sensitive information and manage the content carefully is needed.

### SUMMARY

Embodiments of the disclosure provide an electronic device capable of sharing content including sensitive information with an external device while effectively protecting the content, and an operating method of the electronic device.

Additional aspects will be set forth in part in the description which follows and, in part, will be apparent from the description.

According to an example embodiment of the disclosure, a first device includes: a communicator comprising communication circuitry; a memory configured to store one or more instructions; and a processor configured to execute the one or more instructions stored in the memory, wherein the one or more instructions, when executed by the processor, cause the first device to extract sensitive information included in original content to be shared, perform anonymization (as used herein, the term “anonymization” may include, but is not limited to, processing the content to remove and/or obscure certain content, such as, for example, and without limitation, secure content) on the sensitive information to generate anonymized content corresponding to the original content, control the communicator to transmit the anonymized content to a second device, perform authentication in response to a request based on a request for the original content being received from the second device through the communicator, and transmit the original content to the second device based on the authentication being completed.

When a request for sharing the original content is received, the processor may be further configured to execute the one or more instructions to control the first device to determine whether the original content includes the sensitive information.

The first device may further include a display, wherein, when the original content includes the sensitive information, the processor may be further configured to execute the one or more instructions to control the first device to display a message for reconfirming whether to share the original content, on the display.

When the original content includes the sensitive information, the processor may be further configured to execute the one or more instructions to control the first device to set an authentication method for sharing the original content.

The processor may be further configured to execute the one or more instructions to control the first device to control the communicator to transmit a link or data for enabling a user to request the original content to the second device.

The processor may be further configured to execute the one or more instructions to control the first device to sense biometric information in response to the request, and perform the authentication based on the sensed biometric information.

The processor may be further configured to execute the one or more instructions to control the first device to receive a password in response to the request, and perform the authentication based on the password.

The processor may be further configured to execute the one or more instructions to control the first device to set at least one of a period of provision or a number of provisions of the original content that is provided to the second device.

The processor may be further configured to execute the one or more instructions to control the first device to store the original content in a secure folder with a lock function.

According to an example embodiment of the disclosure, a method of operating a first device includes: extracting sensitive information included in original content to be shared; performing anonymization on the sensitive information to generate anonymized content corresponding to the original content; transmitting the anonymized content to a second device; receiving a request for the original content from the second device; performing authentication in response to the request; and transmitting the original content to the second device based on the authentication being completed.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 is a diagram illustrating an example first device and an example second device, according to an embodiment of the disclosure;

FIG. 2 is a block diagram illustrating an example configuration of a first device according to an embodiment of the disclosure;

FIG. 3 is a flowchart illustrating an example method in which a first device shares content including sensitive information with a second device according to an embodiment of the disclosure;

FIG. 4 is a flowchart illustrating an example method in which a first device shares content including sensitive information according to an embodiment of the disclosure;

FIG. 5 is a diagram illustrating an example of an interface screen displayed on a first device according to an embodiment of the disclosure;

FIG. 6 is a diagram illustrating an example method of performing authentication to share content including sensitive information according to an embodiment of the disclosure;

FIG. 7 is a diagram illustrating an example method of performing authentication to share content including sensitive information according to an embodiment of the disclosure;

FIG. 8 is a diagram illustrating an example method in which a first device stores content and anonymized content separately according to an embodiment of the disclosure;

FIG. 9 is a diagram illustrating an example method of storing content in a cloud interworking with a first device according to an embodiment of the disclosure; and

FIG. 10 is a block diagram illustrating an example configuration of a first device according to another embodiment of the disclosure.

### DETAILED DESCRIPTION

Terms used in this disclosure will be briefly described, and the disclosure will be described in greater detail with reference to the drawings.

Although general terms being widely used in the present disclosure were selected as terminology used in the disclosure while considering the functions of the disclosure, they may vary according to intentions of one of ordinary skill in the art, judicial precedents, the advent of new technologies, and the like. Terms arbitrarily selected may also be used in a specific case. In this case, their meanings will be described in detail in the detailed description of the disclosure. The terms must be defined based on the meanings of the terms and the contents of the entire disclosure, not by simply stating the terms themselves.

It will be understood that when a certain part “includes” a certain component, the part does not exclude another component but can further include another component, unless the context clearly dictates otherwise. As used herein, the terms “portion”, “module”, or “unit” refers to a unit that can perform at least one function or operation, and may be implemented as hardware or software or as a combination of hardware and software.

Hereinafter, various example embodiments of the disclosure will be described in greater detail with reference to the accompanying drawings. However, the disclosure may be embodied in different forms and should not be understood as being limited to the example embodiments set forth herein. Also, in the drawings, portions irrelevant to the description may not be shown in order to more clearly describe the disclosure, and throughout the entire disclosure, similar components may be assigned like reference numerals.

Throughout the disclosure, the expression “at least one of a, b or c” indicates only a, only b, only c, both a and b, both a and c, both b and c, all of a, b, and c, or variations thereof.

In the embodiments of the specification, the term “user” may refer, for example, to a person who controls a system, functions or operations, and may include a developer, a manager, or an installation engineer.

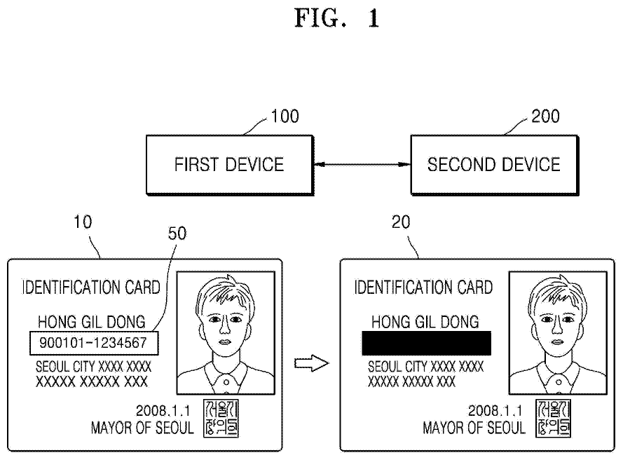

FIG. 1 is a diagram illustrating an example first device 100 and an example second device 200 according to an embodiment of the disclosure.

The first device 100 according to an embodiment of the disclosure may be a device that attempts to share content, and may be a device of a content transmission side. The second device 200 according to an embodiment of the disclosure may be a device sharing content received from the first device 100, and may be a device of a content reception side.

The first device 100 and the second device 200 according to an embodiment of the disclosure may be implemented as various types of electronic devices. For example, the various types of electronic devices may include, for example, and without limitation, a mobile phone, a smart phone, a laptop computer, a desktop computer, a tablet PC, an e-book terminal, a digital broadcast terminal, a personal digital assistants (PDA), a portable multimedia player (PMP), a navigation system, a MP3 player, a camcorder, an internet protocol television (IPTV), a digital television (DTV), a wearable device, etc., although not limited thereto.

The first device 100 may share content with the second device 200. Content 10 according to an embodiment of the disclosure may include, for example, and without limitation, image content, audio content, video content, text content, etc., although not limited thereto.

The content 10 according to an embodiment of the disclosure may include sensitive information 50. For example, the sensitive information 50 may include personal information, such as a person's name, resident registration number, passport number, telephone number, etc. The sensitive information 50 is not limited to the above-mentioned information, and may be a concept including various types of information that a user wants to protect.

The content 10 according to an embodiment of the disclosure may include, for example, image content acquired by photographing various types of objects on which sensitive information is written, such as a physical medium (for example, an identification card, a passport, a credit card and a business card) and document (for example, hospital records, papers, a bill of a delivery box or a mail, etc.).

The first device 100 may transmit the content 10 including the sensitive information 50 to the second device 200 (or share the content 10 including the sensitive information 50 with the second device 200). In this case, the first device 100 may extract the sensitive information 50 included in the content 10, and perform anonymization on the extracted sensitive information 50. The anonymization may include, for example, processing of converting the entire or a part of sensitive information (for example, personally identifiable information, etc.) so that a person is not identified through the sensitive information. For example, the anonymization may include, for example, and without limitation, alias processing of replacing a part of an identification element included in sensitive information with a different value, aggregation of showing a comprehensive value of sensitive information without showing individual data, processing of deleting some identification elements, categorization of hiding an accurate value of data and converting the data into a category value, masking of making an important identifier invisible, etc., although not limited thereto.

For example, the first device 100 may perform non-visualization processing on the sensitive information 50. The first device 100 may mask the sensitive information 50 with a quadrangle image, etc. Also, the first device 100 may perform blurring of blurring the sensitive information 50. However, a method of performing anonymization on the sensitive information 50 is not limited to the above-described methods, and other methods may be used.

The first device 100 according to an embodiment of the disclosure may transmit anonymized content 20 obtained by performing anonymization on the sensitive information 50 to the second device 200.

The second device 200 may request the first device 100 to transmit the content (hereinafter, also referred to as “original content”) 10 not subject to anonymization. When the first device 100 receives a request for the original content 10 from the second device 200, the first device 100 may perform authentication, and, when the authentication is completed, the first device 100 may transmit the original content 10 including the sensitive information to the second device 200.

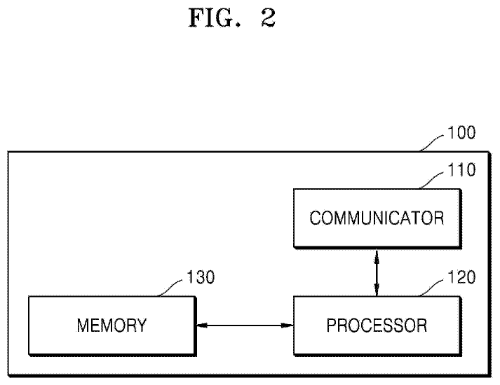

FIG. 2 is a block diagram illustrating an example configuration of the first device 100 according to an embodiment of the disclosure.

Referring to FIG. 2, the first device 100 according to an embodiment of the disclosure may include a communicator (e.g., including communication circuitry) 110, a memory 130, and a processor (e.g., including processing circuitry) 120.

The processor 120 according to an embodiment of the disclosure may include various processing circuitry and control overall operations of the first device 100. The processor 120 may execute one or more programs stored in the memory 130.

The communicator 110 may include various communication circuitry and transmit/receive data or signals to/from an external device or an external server by a control of the processor 120.

The communicator 110 may include one or more components including various communication circuitry to enable communications through a communication network, such as a local area network (LAN), a wide area network (WAN), a value added network (VAN), a mobile radio communication network, and a satellite communication network, and a combination of the communication networks. Also, the communicator 110 may wirelessly transmit/receive data or signals directly to/from an external device or an external server using a wireless LAN (for example, wireless-fidelity (Wi-Fi), etc.).

The communicator 110 according to an embodiment of the disclosure may transmit anonymized content obtained by performing anonymization on content or sensitive information included in the content to an external device (for example, the second device 200). The communicator 110 may transmit a link or data for enabling a user to request original content corresponding to the anonymized content, together with the anonymized content, to the external device. The communicator 110 may receive a request for the original content corresponding to the anonymized content from the external device.

The memory 130 according to an embodiment of the disclosure may store various data, programs or applications for driving and controlling the first device 100. The memory 130 may store the original content including the sensitive information and the anonymized content separately. For example, the memory 130 according to an embodiment of the disclosure may store the original content including the sensitive information in a secure storage space.

A program stored in the memory 130 may include one or more instructions. The program (the one or more instructions) or application stored in the memory 130 may be executed by the processor 120 which may, in turn, control the first device 100 to perform various operations. It will be understood that where it is described that the processor performs a particular operation, this also includes the processor controlling the first device to perform the operation.

When the processor 120 according to an embodiment of the disclosure receives a request for transmitting content to the second device 200 or a request for sharing content with the second device 200, the processor 120 may determine whether the content includes sensitive information. When the processor 120 determines that the content includes no sensitive information, the processor 120 may control the communicator 110 to transmit the content to the second device 200.

On the other hand, when the processor 120 determines that the content includes sensitive information, the processor 120 may perform anonymization on the sensitive information to create anonymized content. The processor 120 may control the communicator 110 to transmit the anonymized content to the second device 200. In this case, the processor 120 may control the communicator 110 to transmit a link or data for enabling a user to request original data corresponding to the anonymized content, together with the anonymized content, to the second device 200.

When the processor 120 receives a request for the original content corresponding to the anonymized content from the second device 200, the processor 120 may perform predetermined authentication.

According to an embodiment of the disclosure, an authentication method for sharing original content may have been set in advance. For example, the processor 120 may perform authentication based on a user's biometric information, the user using the first device 100, or using a password or a one time password (OTP).

When the authentication is completed, the processor 120 may control the communicator 110 to transmit the original content for the anonymized content to the second device 200. The processor 120 may set a period of use or a number of uses of the original content for the second device 200.

The block diagram of the first device100 illustrated in FIG. 2 is a block diagram for an embodiment of the disclosure. Some components included in the block diagram may be integrated or omitted, or another component may be added, according to an actual specification of the first device 100. For example, two or more components may be integrated into one component, or one component may be separated into two or more components, as necessary. Also, functions performed in the individual blocks are provided to describe the embodiments of the disclosure, and detailed operations or devices for the functions do not limit the scope of rights of the disclosure.

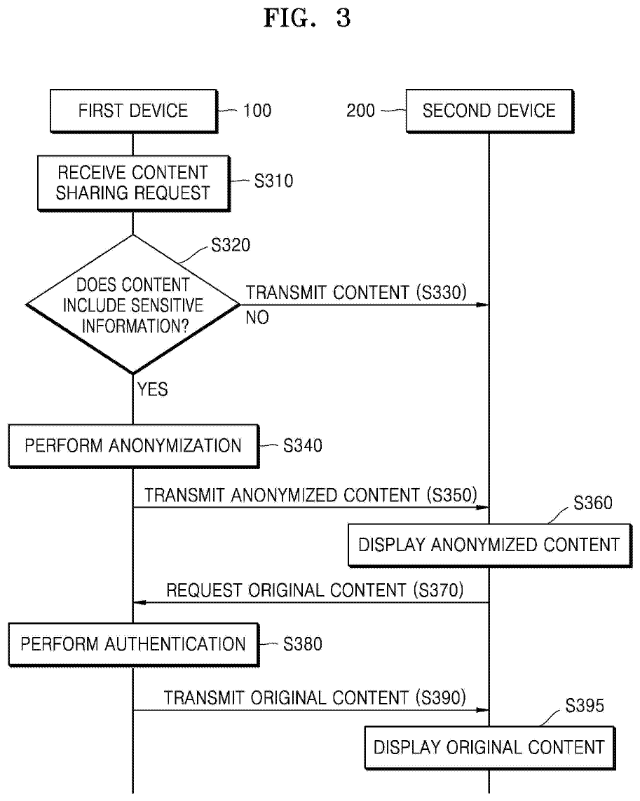

FIG. 3 is a flowchart illustrating an example method in which the first device 100 shares content including sensitive information with the second device 200 according to an embodiment of the disclosure.

Referring to FIG. 3, the first device 100 according to an embodiment of the disclosure may receive a content sharing request or a content transmitting request, in operation S310. For example, a user of the first device 100 may input a sharing request through, for example, and without limitation, a message, a mail, a messenger, a SNS application, etc., although not limited thereto.

When the first device 100 receives the content sharing request, the first device 100 may determine whether content that is to be shared includes sensitive information, in operation S320.

For example, the sensitive information may include personal information, such as a person's name, resident registration number, passport number, telephone number, etc., and may be a concept including various types of information that a user wants to protect.

Content including sensitive information according to an embodiment of the disclosure may be image content acquired by photographing various types of objects on which sensitive information is written, such as, for example, and without limitation, an identification card, a passport, a credit card, hospital records, papers, etc., or a digital file (for example, an image file, a document file, etc.) on which sensitive information is written.

The first device 100 may recognize sensitive information from the content. For example, the first device 100 may train a criterion for sensitive information, and determine whether the content includes sensitive information, based on the trained criterion. The first device 100 may recognize sensitive information included in the content using a sensitive information recognition model already trained. In this case, the sensitive information recognition model may be a model trained and established by the first device 100 or a model received from the outside. However, the sensitive information recognition model is not limited thereto.

When the content according to an embodiment of the disclosure is image content, the first device 100 may recognize sensitive information from the image based on edge information, shape information, color distribution information, etc. for the image, although not limited thereto. However, the first device 100 may recognize sensitive information from the image content by using various image recognition techniques.

When the first device 100 determines that the content includes no sensitive information (“No” in operation S320), the first device 100 may transmit the content to the second device 200, in operation S330.

When the first device 100 determines that the content includes sensitive information (“Yes” in operation S320), the first device 100 may perform anonymization on the sensitive information, in operation S340. For example, the first device 100 may mask the sensitive information with a quadrangle image, etc. or blur the sensitive information to make the sensitive information invisible. However, a method of performing anonymization on the sensitive information is not limited to these, and various methods may be performed.

The first device 100 may transmit anonymized content obtained by performing the anonymization to the second device 200, in operation S350. The first device 100 may transmit a link or data for enabling a user to request original content corresponding to the anonymized content, together with the anonymized content, to the second device 200.

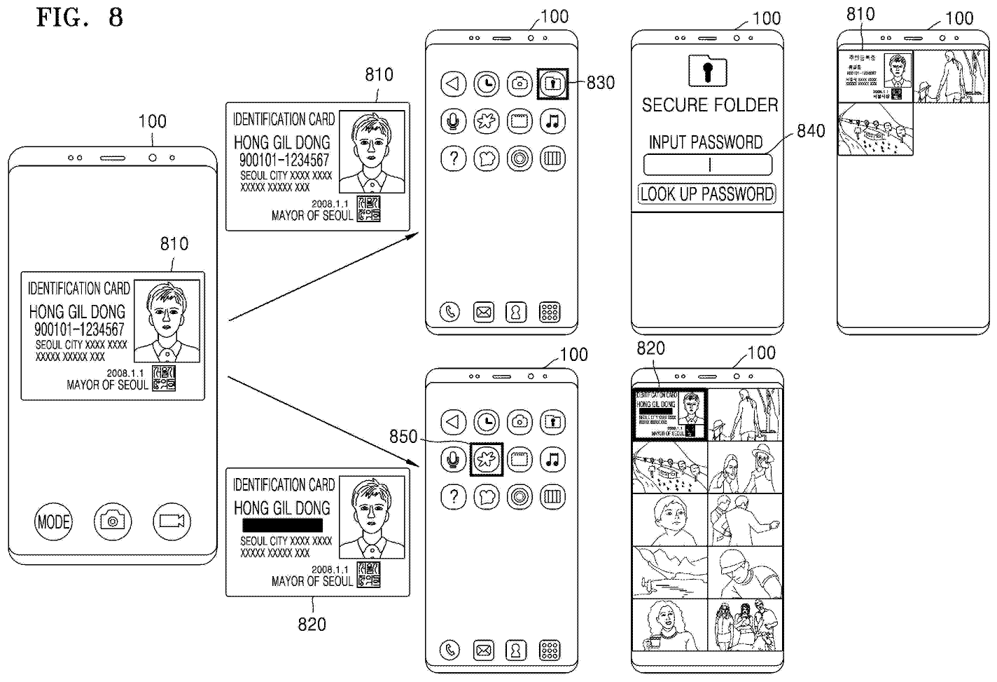

The first device 100 may store the anonymized content and the original content in separate storage spaces. For example, the first device 100 may store the anonymized content in a general folder and the original content in a secure folder with a lock function. This will be described in greater detail below with reference to FIG. 8.

The second device 200 according to an embodiment of the disclosure may display the anonymized content received from the first device 100, in operation S360. A user of the second device 200 may check the anonymized content displayed on the second device 200, and, when the user determines that the original content is needed, the user may request the first device 100 to transmit the original content corresponding to the anonymized content, in operation S370. For example, the user of the second device 200 may request the original content by making an input of selecting the link or data received from the first device 100. However, a method of requesting the original content is not limited thereto.

When the first device 100 receives the request for the original content, the first device 100 may perform authentication, in operation S380. For example, the first device 100 may perform authentication based on the user's biometric information (for example, fingerprint information, iris information, etc.) or a password, although not limited thereto. However, the first device 100 may perform authentication by other methods.

When the authentication is completed, the first device 100 may transmit the original content including the sensitive information to the second device 200, in operation S390. The first device 100 may set at least one of a period of provision or a number of provisions of the original content.

The second device 200 may display the original content received from the first device 100, in operation S395, and, when the period of provision or the number of provisions set in the original content expires, the second device 200 may delete the original content and no longer display the original content.

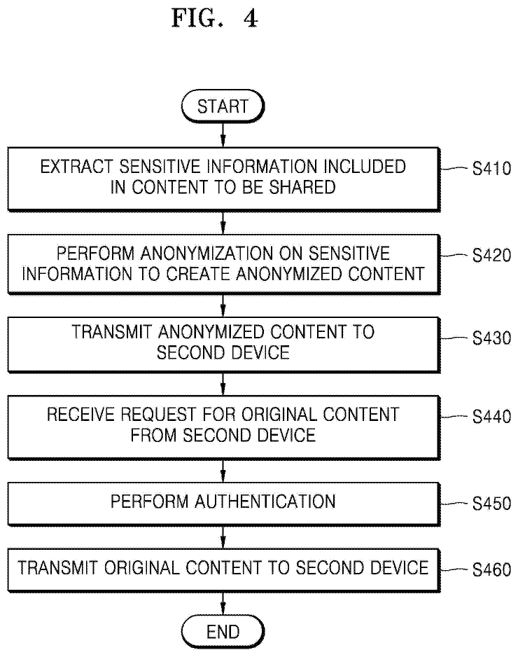

FIG. 4 is a flowchart illustrating an example method in which the first device 100 shares content including sensitive information according to an embodiment of the disclosure.

Referring to FIG. 4, when the first device 100 according to an embodiment of the disclosure receives a sharing request for content, the first device 100 may extract sensitive information included in the content to be shared in operation S410.

For example, the sensitive information may include personal information, such as a person's name, resident registration number, passport number, telephone number, etc., and may be a concept including various types of information that a user wants to protect.

A method of extracting (recognizing) the sensitive information has been described in detail in operation S320 of FIG. 3, and therefore, overlapping descriptions may not be repeated here.

The first device 100 may perform anonymization on the sensitive information to create anonymized content in operation S420. A method of performing anonymization has been described in detail in operation S340 of FIG. 3, and therefore, overlapping descriptions may not be repeated here.

The first device 100 may transmit the anonymized content to the second device 200 in operation S430 and receive a request for original content from the second device 200 in operation S440.

After the first device 100 receives the request for the original content, the first device 100 may perform authentication in operation S450. For example, the first device 100 may perform authentication based on the user's biometric information (for example, fingerprint information, iris information, etc.) or a password, although not limited thereto. However, the first device 100 may perform authentication by other methods.

When the authentication is completed, the first device 100 may transmit the original content including the sensitive information to the second device 200 in operation S460. The first device 100 may set a period of provision or a number of provisions of the original content, and transmit information about the period of provision or the number of provisions of the original content to the second device 200.

Accordingly, the first device 100 according to an embodiment of the disclosure may share content including sensitive information with the second device 200 while effectively protecting the sensitive information.

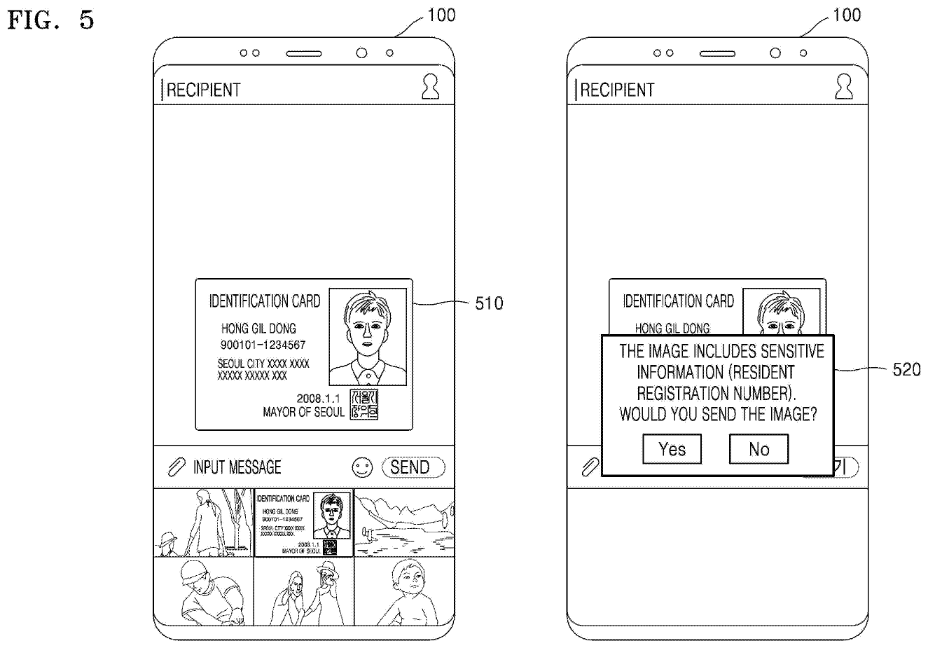

FIG. 5 is a diagram illustrating an example of an interface screen displayed on the first device 100 according to an embodiment of the disclosure.

The first device 100 according to an embodiment of the disclosure may use a message application to request content transmission to an external device (for example, the second device 200). For example, the message application may be a text message application, an e-mail application, a messenger application, a SNS application, etc., although not limited thereto.

Referring to FIG. 5, the first device 100 may use a file attachment function to select a first image file from among image files stored in the first device 100. When the first image file is selected, the first device 100 may determine whether a first image 510 includes sensitive information. The first image 510 according to an embodiment of the disclosure may be image content including sensitive information. When the first device 100 determines that the selected image content includes sensitive information, the first device 100 may display a notification message 520, as shown in FIG. 5. The first device 100 may extract the sensitive information from the first image 510, and determine a kind (for example, a resident registration number, a passport number, a credit card number, etc.) of the extracted sensitive information. The notification message 520 according to an embodiment of the disclosure may include a kind of the sensitive information extracted from the first image 510, and be a message requesting a user to determine whether to transmit the corresponding content.

Accordingly, the first device 100 may warn the user before transmitting the content including the sensitive information to the external device, thereby preventing the sensitive information (for example, personal information) from leaking out unintentionally.

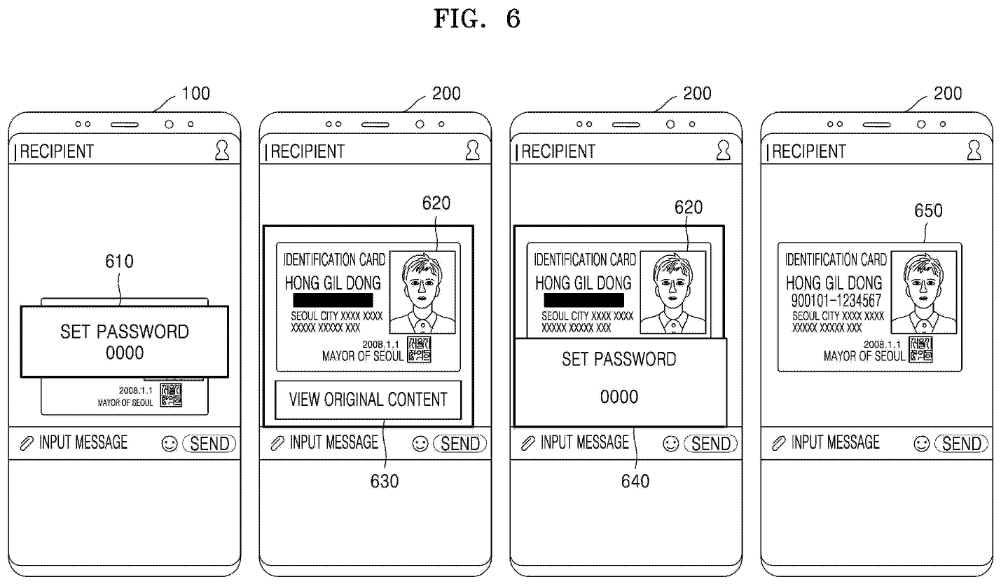

FIG. 6 is a diagram illustrating an example method of performing authentication according to an embodiment of the disclosure to share content including sensitive information.

Referring to FIG. 6, the first device 100 may set an authentication method for sharing content including sensitive information. For example, the first device 100 may set an authentication method for sharing content to a password method.

When a password for the content is set (610), the first device 100 may create an encryption key based on the password, and encrypt the sensitive information included in the content by using the encryption key. In this case, the encrypted sensitive information may appear in a blurred shape.

The first device 100 may transmit anonymized content 620 obtained by encrypting the sensitive information to the second device 200. The second device 200 may display the anonymized content 620 received from the first device 100, and display an object 630 requesting restoration of the encrypted sensitive information, together with the anonymized content 620.

When a user of the second device 200 selects the object 630, the second device 200 may display a password input window 640. When a password is input, the second device 200 may determine whether the input password is identical to a predetermined password, and, when the second device 200 determines that the input password is identical to the predetermined password, the second device 200 may restore the sensitive information to its original form using a decryption key based on the password.

When the password is input, the second device 200 may transmit the password to the first device 100, and the first device 100 may determine whether the received password is identical to the predetermined password. When the first device 100 determines that the received password is identical to the predetermined password, the first device 100 may transmit a decryption key to the second device 200. The second device 200 may restore the sensitive information to its original form based on the decryption key received from the first device 100. However, a restoring method is not limited thereto.

The second device 200 may display original content 650 obtained by restoring the sensitive information to its original form, and accordingly, the user of the second device 200 may check the sensitive information included in the restored content (the original content 650). At this time, a period for which the original content 650 is displayed or a number of times by which the original content 650 is displayed may be limited.

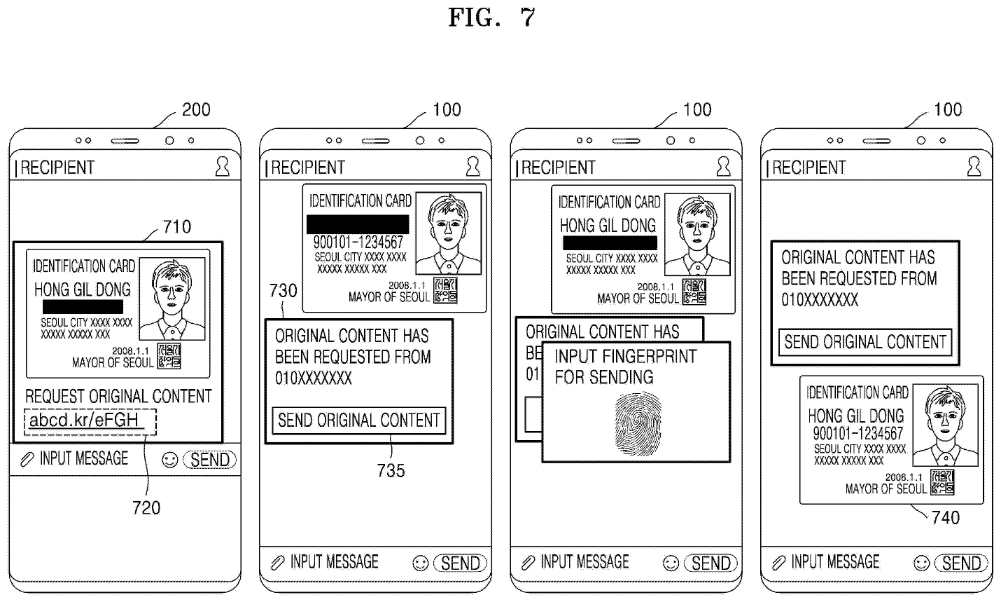

FIG. 7 is a diagram illustrating an example method of performing authentication to share content including sensitive information according to an embodiment of the disclosure.

Referring to FIG. 7, the second device 200 may receive anonymized content 710 from the first device 100 through a message application. The second device 200 may receive a link or data 720 for enabling a user to request original content corresponding to the anonymized content 710, and display the link or data 720.

A user of the second device 200 may select the link or data 720, and, when the second device 200 receives an input of selecting the link or data 720, the second device 200 may request the first device 100 to transmit the original content.

When the first device 100 receives a request for the original content from the second device 200, the first device 100 may display an original content request message 730. For example, the original content request message 730 may include an object 735 related to transmission of the original content. When the first device 100 receives a user's input of selecting the object 735, the first device 100 may perform authentication.

The first device 100 may perform authentication based on a user's biometric information (for example, fingerprint information, iris information, etc.) or a password, although not limited thereto, wherein the user is a user of the first device 100. However, the first device 100 may perform authentication by other methods. For example, as shown in FIG. 7, the first device 100 may perform biometric authentication using the user's fingerprint information.

When the first device 100 determines that input fingerprint information is identical to or matches predetermined fingerprint information, the first device 100 may transmit original content 740 including sensitive information to the second device 200 At this time, the first device 100 may set at least one of a period of provision or a number of provisions of the original content 740.

For example, when the period of provision of the original content 740 expires, the second device 200 may delete the original content 740 and no longer display the original content 740.

FIG. 8 is a diagram illustrating an example method in which the first device 100 stores content and anonymized content separately according to an embodiment of the disclosure.

Referring to FIG. 8, the first device 100 may store content including sensitive information, and anonymized content created by performing anonymization on the sensitive information of the content, separately.

The first device 100 according to an embodiment of the disclosure may acquire content 810 (for example, an identification card image) including sensitive information. For example, the first device 100 may acquire an identification card image 810 by photographing an identification card through a camera application. The identification card image 810 may include a resident registration number.

The first device 100 may recognize sensitive information from the photographed content (the identification card image 810) and perform anonymization on the sensitive information to create anonymized content 820. For example, the first device 100 may recognize the resident registration number from the identification card image 810 and perform anonymization on the resident registration number to create the anonymized content 820.

As shown in FIG. 8, the first device 100 may store the identification card image 810 including the resident registration number in a secure folder 830. The secure folder 830 may be a folder having a lock function.

For example, when a user of the first device 100 selects the secure folder 830 to check content stored in the secure folder 830, the first device 100 may perform user authentication. For example, the first device 100 may display a password input window 840 for requesting the user to input a predetermined password set in the secure folder 830. When the first device 100 determines that an input password is identical to the predetermined password, the first device 100 may display the identification card image 810 stored in the secure folder 830. However, the first device 100 may perform biometric authentication based on the user's biometric information (for example, fingerprint information, voice information or iris information), instead of password authentication.

The first device 100 may perform additional user authentication on predetermined content stored in the secure folder 830. For example, the first device 100 may set a predetermined password for the predetermined content stored in the secure folder 830, and, when the first device 100 determines that an input password is identical to the predetermined password, the first device 100 may provide the corresponding content.

On the other hand, the first device 100 may store the anonymized content 820 (that is, an anonymized identification card image) in a general folder 850 (for example, a gallery application).

For example, when the user of the first device 100 selects the gallery folder 850 to check content stored in the gallery folder 850, the first device 100 may display the anonymized identification card image 850 stored in the gallery folder 850 without performing user authentication.

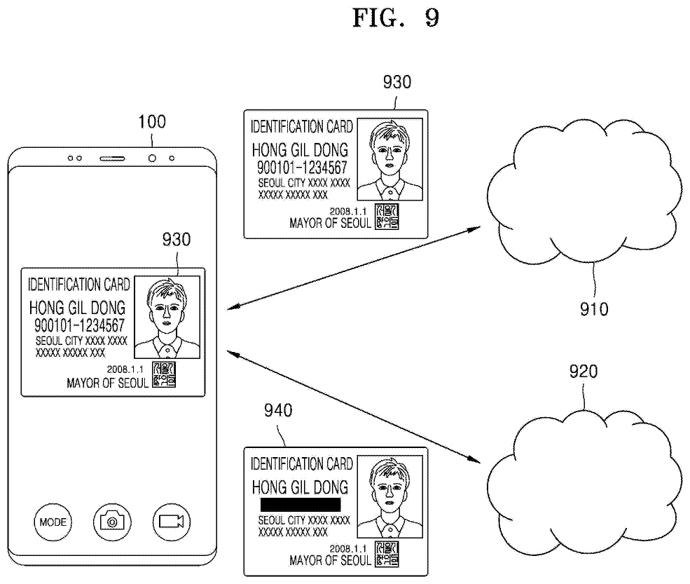

FIG. 9 is a diagram illustrating an example method of storing content in a cloud interworking with the first device 100 according to an embodiment of the disclosure.

Referring to FIG. 9, a first cloud 910 and a second cloud 920 according to an embodiment of the disclosure may be clouds interworking with the first device 100. For example, the first device 100 may upload content, etc. to the first cloud 910 or the second cloud 920, and the first cloud 910 or the second cloud 920 may store the content, etc. received from the first device 100.

The first device 100 according to an embodiment of the disclosure may make a setting about whether to upload content including sensitive information, based, for example, on a user input, when setting up an interworking relationship with the first cloud 910 and the second cloud 920. For example, the first device 100 may make a setting of uploading content including sensitive information to the first cloud 910 and not uploading content including sensitive information to the second cloud 920.

Referring to FIG. 9, the first device 100 may acquire content 930. For example, the first device 100 may acquire image content by photographing an object through a camera application. The first device 100 may determine whether the acquired content 930 includes sensitive information, and, when the first device 100 determines that the acquired content 930 includes no sensitive information, the first device 100 may upload (store) the acquired content 930 to the first cloud 910 and the second cloud 920.

When the first device 100 determines that the acquired content 930 includes sensitive information, the first device 100 may upload the acquired content 930 to the first cloud 910 without uploading the acquired content 930 to the second cloud 920.

When there is no setting about whether to upload content including sensitive information to which the first cloud 910 and the second cloud 920, the first device 100 may display a message of inquiring about whether to upload the acquired content 930 to which one of the first cloud 910 and the second cloud 920. The first device 100 may upload content including sensitive information to the first cloud 910 or the second cloud 920, based on a user's input, although not limited thereto.

The first device 100 may recognize the sensitive information from the acquired content 930 (for example, an identification card image) and perform anonymization on the sensitive information to create anonymized content 940. For example, the first device 100 may recognize a resident registration number from an identification card image and perform anonymization on the resident registration number to create the anonymized content 940.

The first device 100 may upload the content 930 (also referred to as original content) to the first cloud 910 and the anonymized content 940 to the second cloud 920, respectively.

In this way, the first device 100 according to an embodiment of the disclosure may upload content including sensitive information to a cloud interworking with the first device 100, while effectively protecting the sensitive information.

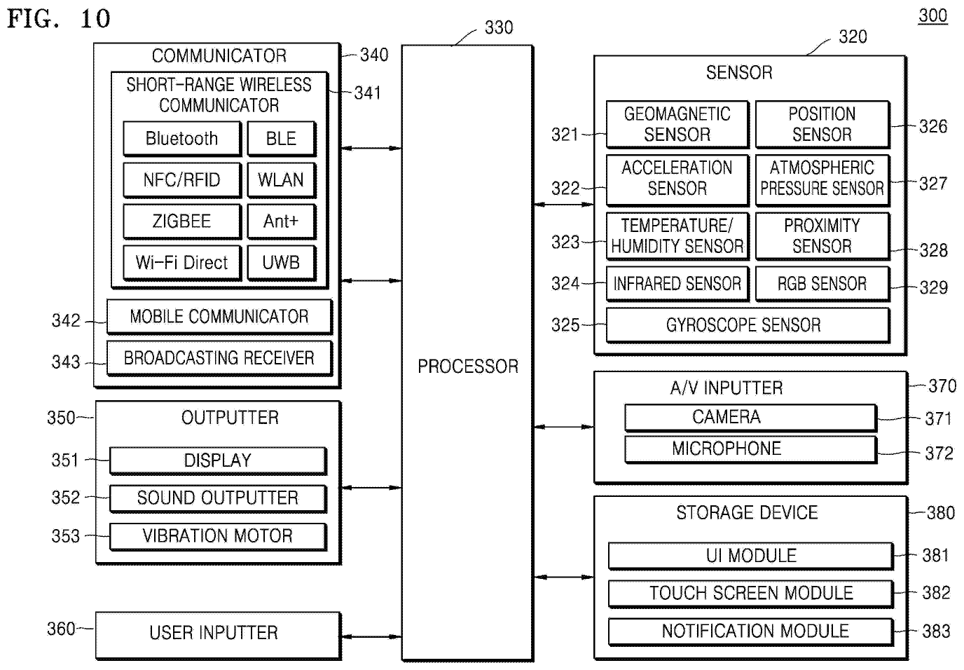

FIG. 10 is a block diagram illustrating an example configuration of a first device 300 according to another embodiment of the disclosure. The first device 300 of FIG. 10 may be an embodiment of the first device 100 of FIG. 1.

Referring to FIG. 10, the first device 300 according to an embodiment of the disclosure may include a processor (e.g., including processing circuitry) 330, a sensor 320, a communicator (e.g., including communication circuitry) 340, an outputter (e.g., including output circuitry) 350, a user inputter (e.g., including user input circuitry) 360, an A/V inputter (e.g., including A/V input circuitry) 370, and a storage device 380.

The communicator 340 of FIG. 10 may correspond to the communicator 110 of FIG. 2, the processor 330 of FIG. 10 may correspond to the processor 120 of FIG. 2, and the storage device 380 of FIG. 10 may correspond to the memory 130 of FIG. 2. Hereinafter, the same descriptions as those given above with reference to FIG. 2 may not be repeated here.

The communicator 340 may include various communication circuitry, including, for example, one or more components for performing communication between the first device 300 and an external device (for example, a second device, etc.). For example, the communicator 340 may include a short-range wireless communicator 341, a mobile communicator 342, and a broadcast receiver 343.

The short-range wireless communicator 341 may include various communication circuitry, such as, for example, a Bluetooth communicator, a Bluetooth Low Energy (BLE) communicator, a Near-Field Communication (NFC) unit, a Wireless Local Access Network (WLAN: Wi-Fi) communicator, a Zigbee communicator, an Infrared Data Association (IrDA) communicator, a Wi-Fi Direct (WFD) communicator, a Ultra Wideband (UWB) communication module, and an Ant+ communicator, although not limited thereto.

The mobile communicator 342 may transmit/receive a wireless signal to/from at least one of a base station, an external terminal, or a server on a mobile communication network. Herein, the wireless signal may include a voice call signal, a video call signal or various formats of data according to transmission/reception of text/multimedia messages.

The broadcasting receiver 343 may receive a broadcasting signal and/or broadcasting-related information from the outside through a broadcasting channel. The broadcasting channel may include a satellite channel and a terrestrial channel. According to implementation examples, the first device 300 may not include the broadcasting receiver 343.

The outputter 350 may include various output circuitry and be used to output audio signals, video signals or vibration signals, and may include various output circuitry including, for example, and without limitation, a display 351, a sound outputter 352, and a vibration motor 353.

The display 351 according to an embodiment of the disclosure may convert image signals, data signals, on screen display (OSD) signals, control signals, etc., processed by the processor 330, to generate driving signals. The display 351 may be implemented, for example, and without limitation, as a plasma display panel (PDP) display, a liquid crystal display (LCD), an organic light-emitting diode (OLED) display, a flexible display, etc. The display 351 may be implemented as a three-dimensional (3D) display. The display 351 may be configured as a touch screen, and used as an input device, as well as an output device.

The display 351 according to an embodiment of the disclosure may display content acquired from the first device 300, and may also display anonymized content obtained by performing anonymization on sensitive information included in the content.

The sound outputter 352 may include various sound output circuitry and output audio data received from the communicator 340 or stored in the storage device 380. The sound outputter 352 may output a sound signal related to a function (for example, call signal reception sound, message reception sound, and notification sound) that is performed in the first device 300. The sound outputter 352 may be a speaker, a buzzer, etc.

The vibration motor 353 may output a vibration signal. For example, the vibration motor 353 may output vibration signals corresponding to outputs of audio data or video data (for example, call signal reception sound, message reception sound, etc.). The vibration motor 353 may output a vibration signal when a touch is input to the touch screen.

The processor 330 may include various processing circuitry and control overall operations of the first device 300. For example, the processor 330 may execute programs stored in the storage device 380 to control the communicator 340, the outputter 350, the user inputter 360, the sensor 320, the A/V inputter 370, etc.

The user inputter 360 may include various user input circuitry for enabling a user to input data for controlling the first device 300. For example, the user inputter 360 may include a key pad, a dome switch, a touch pad (a contact capacitive type, a pressure resistive type, an infrared beam type, a surface acoustic wave type, an integral strain gauge type, a piezo effect type, etc.), a jog wheel, a jog switch, etc., although not limited thereto.

The sensor 320 may include a sensor for sensing a state of the first device 300 or a state of surroundings of the first device 300, as well as a sensor (for example, a fingerprint recognition sensor) for sensing a user's biometric information. Also, the sensor 320 may transfer sensed information to the processor 330.

The sensor 320 may include at least one among a geomagnetic sensor 321, an acceleration sensor 322, a temperature/humidity sensor 323, an infrared sensor 324, a gyroscope sensor 325, a position sensor (for example, a global positioning system (GPS)) 326, an atmospheric pressure sensor 327, a proximity sensor 328, an RGB sensor (illuminance sensor) 329, or the like, although not limited thereto. Functions of the individual sensors are intuitively inferred by one of ordinary skill in the art from their names, and therefore, detailed descriptions thereof will be omitted.

The A/V inputter 370 may include various A/V input circuitry and be used to enable a user to input an audio signal or a video signal, and may include a camera 371 and a microphone 372. The camera 371 may acquire an image frame, such as a still image or a moving image, through an image sensor in a video call mode or a photographing mode. An image captured by the image sensor may be processed by the processor 330 or a separate image processor (not shown).

An image frame processed by the camera 371 may be stored in the storage device 380 or transmitted to the outside through the communicator 340. Two or more cameras 371 may be provided according to a configuration aspect of the first device 300.

The microphone 372 may receive a sound signal from the outside and process the sound signal into electrical voice data. For example, the microphone 372 may receive a sound signal from an external device or a speaker. The microphone 372 may use various noise removal algorithms to remove noise generated upon receiving a sound signal from the outside.

The storage device 380 may store a program for processing and controlling the processor 330, and store input/output data (for example, applications, content, time-zone information of an external device, an address book, etc.).

The storage device 380 may include at least one type of storage medium among a flash memory type, a hard disk type, a multimedia card micro type, a card type memory (e.g., SD or XD memory), Random Access Memory (RAM), Static Random Access Memory (SRAM), Read Only Memory (ROM), Electrically Erasable Programmable Read-Only Memory (EEPROM), Programmable Read-Only Memory (PROM), a magnetic memory, a magnetic disk, or an optical disk. Also, the first device 300 may operate a web storage or a cloud server that performs a storage function of the storage device 380 on the Internet.

Programs stored in the storage device 380 may be classified into a plurality of modules according to their functions, and, for example, the programs may be classified into a UI module 381, a touch screen module 382, a notification module 383, etc.

The UI module 381 may include various UI circuitry and provide a specialized UI or GUI interworking with the first device 300 for each application. The touch screen module 382 may sense a user's touch gesture made on the touch screen, and transfer information about the user's touch gesture to the processor 330.

The touch screen module 382 may recognize and analyse a touch code. The touch screen module 382 may be configured as separate hardware including a controller.

The notification module 383 may generate a signal for informing event occurrence of the first device 300. Examples of events that occur in the first device 300 may be call signal reception, message reception, a key signal input, schedule notification, etc. The notification module 383 may output a notification signal in the form of a video signal through the display 351, output a notification signal in the form of an audio signal through the sound outputter 352, or output a notification signal in the form of a vibration signal through the vibration motor 353.

The block diagram of the first device 300 illustrated in FIG. 10 is a block diagram for an example embodiment of the disclosure. Some components included in the block diagram may be integrated or omitted, or another component may be added, according to an actual specification of the first device 300. For example, two or more components may be integrated into one component, or one component may be separated into two or more components, as necessary. Also, functions performed in the individual blocks are provided to describe the embodiments of the disclosure, and detailed operations or devices for the functions do not limit the scope of rights of the disclosure.

The operating method of the first device according to an example embodiment of the disclosure may be implemented in the form of a program command that is executable by various computer means, and may be recorded on computer-readable media. The computer-readable media may also include, alone or in combination with program commands, data files, data structures, and the like. Program commands recorded in the media may be the specifically designed and constructed for the purposes of the disclosure or well-known and available to those of ordinary skill in the computer software field. Examples of the computer-readable media include magnetic media (for example, hard disks, floppy disks, and magnetic tapes), optical media (for example, CD-ROM and DVD), magneto-optical media (for example, floptical disks), and hardware devices (for example, ROM, RAM, flash memory, and the like), specifically configured to store and execute program commands. Examples of the program commands include high-level language codes including a code made by a compiler or a code executable by an interpreter or the like, as well as machine language codes produced by a compiler.

An operating method of a first device, according to the disclosed embodiments of the disclosure, may be included in a computer program product and provided. The computer program product may be traded between a seller and a purchaser.

The computer program product may include a software (S/W) program and a computer-readable storage medium storing a S/W program. For example, the computer program product may include a S/W program product (for example, a downloadable application) electronically distributed through a manufacturing company of an electronic device or an electronic market (for example, Google Play Store™ or App Store™). For electronic distribution, at least one part of the software program may be stored in a storage medium or temporarily created. In this case, the storage medium may be a server of a manufacturing company, a server of an electronic market, or a storage medium of a relay server that temporarily stores a S/W program.

In a system configured with a server and a client, the computer program product may include a storage medium of the server or a storage medium of the client. Also, when there is a third device (for example, a smart phone) communicating with the server or the client, the computer program product may include a storage medium of the third device. Also, the computer program product may include a S/w program that is transmitted from the server to the client or the third device or from the third device to the client.

In this case, one of the server, the client and the third device may execute the computer program product to perform the method according to the disclosed embodiments of the disclosure. Also, two or more of the server, the client, and the third device may execute the computer program product to distributively perform the method according to the disclosed embodiments of the disclosure.

For example, the server (for example, a cloud server or an artificial intelligence (AI) server) may execute the computer program product stored in the server to control the client communicating with the server to perform the method according to the disclosed embodiments of the disclosure.

The electronic device according to an embodiment of the disclosure may cause, before sharing content including sensitive information with an external device or uploading the content to the external device, a user to recognize the content including the sensitive information and manage the content carefully.

The electronic device according to an embodiment of the disclosure may effectively protect sensitive information when sharing content including the sensitive information with an external device or uploading the content to the external server.

It will be apparent to those of ordinary skill in the art that various modifications and variations can be made without departing from the spirit and scope of the disclosure.

What is claimed is:

1. A first device comprising:
a communicator comprising communication circuitry;
a memory configured to store one or more instructions; and
a processor configured to execute the one or more instructions stored in the memory,
wherein the processor is configured to execute the one or more instructions to control the first device to:
extract sensitive information included in original content to be shared,
perform anonymization on the sensitive information to generate anonymized content corresponding to the original content,
control the communicator to transmit the anonymized content to a second device,
perform, based on a request for the original content being received from the second device through the communicator, authentication in response to the request, and
transmit the original content to the second device based on the authentication being completed.

2. The first device of claim 1, wherein, based on a request for sharing the original content being received, the processor is further configured to execute the one or more instructions to control the first device to determine whether the original content includes the sensitive information.

3. The first device of claim 2, further comprising a display, wherein, based on the original content including the sensitive information, the processor is further configured to execute the one or more instructions to control the first device to display a message reconfirming whether to share the original content, on the display.

4. The first device of claim 2, wherein, based on the original content including the sensitive information, the processor is further configured to execute the one or more instructions to control the first device to set an authentication method for sharing the original content.

5. The first device of claim 1, wherein the processor is further configured to execute the one or more instructions to control the first device to control the communicator to transmit, to the second device, a link or data enabling a user to request the original content.

6. The first device of claim 1, wherein the processor is further configured to execute the one or more instructions to control the first device to sense biometric information in response to the request, and perform the authentication based on the sensed biometric information.

7. The first device of claim 1, wherein the processor is further configured to execute the one or more instructions to control the first device to receive a password in response to the request, and perform the authentication based on the password.

8. The first device of claim 1, wherein the processor is further configured to execute the one or more instructions to control the first device to set at least one of a period of provision or a number of provisions of the original content provided to the second device.

9. The first device of claim 1, wherein the processor is further configured to execute the one or more instructions to control the first device to store the original content in a secure folder with a lock function.

10. A method of operating a first device, the method comprising:
extracting sensitive information included in original content to be shared;
performing anonymization on the sensitive information to generate anonymized content corresponding to the original content;
transmitting the anonymized content to a second device;
receiving a request for the original content from the second device;
performing authentication in response to the request; and
transmitting the original content to the second device based on the authentication being completed.

11. The method of claim 10, further comprising, based on a request for sharing the original content being received, determining whether the original content includes the sensitive information.

12. The method of claim 11, further comprising, based on the original content including the sensitive information, displaying a message reconfirming whether to share the original content.

13. The method of claim 11, further comprising, based on the original content including the sensitive information, setting an authentication method for sharing the original content.

14. The method of claim 10, wherein the transmitting of the anonymized content comprises transmitting, to the second device, a link or data enabling a user to request the original content.

15. The method of claim 10, wherein the performing of the authentication comprises:
sensing biometric information in response to the request; and
performing the authentication based on the sensed biometric information.

16. The method of claim 10, wherein the performing of the authentication comprises:
receiving a password in response to the request; and
performing the authentication based on the password.

17. The method of claim 10, wherein the transmitting of the original content to the second device comprises:
setting at least one of a period of provision or a number of provisions of the original content provided to the second device.

18. The method of claim 10, further comprising storing the original content in a secure folder with a lock function.

19. A computer program product comprising one or more non-transitory computer-readable recording media storing a program for performing the method of claim 10.
